(19) United States
(12) Patent Application Publication
(10) Pub. No.: US 2026/0071629 A1
(43) Pub. Date: Mar. 12, 2026

(54) CEILING FAN AND WALL-MOUNTED CEILING FAN CONTROL SYSTEM

(71) Applicant: Kuo-Tsun LIN, Taichung City (TW)

(72) Inventor: Kuo-Tsun LIN, Taichung City (TW)

(21) Appl. No.: 19/311,454

(22) Filed: Aug. 27, 2025

(30) Foreign Application Priority Data
Sep. 10, 2024 (TW) 113134281

(51) Int. Cl. F04D 27/00; F04D 25/08; H05B 47/175

(52) U.S. Cl. CPC F04D 27/004; F04D 25/088; H05B 47/175

(57) ABSTRACT

A ceiling fan includes a driver, fan blades, a signal detection module to receive a power signal and output a power control signal, a remote control circuit to receive a remote signal and output a remote control signal, and a controller. The controller controls a rotation speed of the driver based on the remote control signal in response to determining that the power control signal thus received has yet to include a takeover message, and controls the rotation speed of the driver based on the power control signal after determining that the power control signal thus received includes the takeover message.

### CROSS-REFERENCE TO RELATED APPLICATION

This application claims priority to Taiwanese Invention Patent Application No. 113134281, filed on Sep. 10, 2024, the entire disclosure of which is incorporated by reference herein.

### FIELD

The disclosure relates to a ceiling fan and a wall-mounted ceiling fan control system.

### BACKGROUND

A ceiling fan is a fan installed on a ceiling. Compared to a typical standing fan, the ceiling fan operates at a lower rotational speed but generates greater torque and consumes less power, and when used in conjunction with an air conditioning system to circulate indoor air, the ceiling fan can quickly lower (or raise) the indoor temperature. Therefore, in architectural designs with sufficient indoor space, the ceiling fan is a highly popular fixture.

Since conventional ceiling fans are mounted on the ceiling, the conventional ceiling fans are typically used in conjunction with conventional fan control devices to allow users to perform operations such as turning on/off and adjusting the fan speed of the conventional ceiling fans. Remote control operations of the conventional fan control devices generally utilize wireless transmission technologies to establish communication with the conventional ceiling fans. For example, wireless communication may be established using radio frequency (RF), and communication protocols such as Wi-Fi®, Bluetooth®, and ZigBee® may be used for establishing the wireless communication.

However, in buildings with a high density of conventional ceiling fans (e.g., hotels), wireless signals from adjacent ones of the conventional fan control devices (e.g., in neighboring rooms) are prone to interfere with one another, which can result in the conventional ceiling fans failing to operate correctly according to the operations performed by the users.

### SUMMARY

Therefore, an object of the disclosure is to provide a ceiling fan and a wall-mounted ceiling fan control system that can alleviate at least one of the drawbacks of the prior art.

According to an aspect of the disclosure, the ceiling fan includes a driver, a plurality of fan blades, a signal detection module, a remote control circuit, and a controller. The fan blades are connected to the driver, and are rotatably driven by the driver. The signal detection module is configured to receive a power signal, and output a power control signal based on the power signal thus received. The remote control circuit is configured to receive a remote signal, and output a remote control signal based on the remote signal thus received. The controller is electrically connected to the driver, the signal detection module, and the remote control circuit, and is configured to receive the power signal as a power source, receive the power control signal from the signal detection module, and determine whether the power control signal thus received includes a takeover message. The controller is further configured to, control a rotation speed of the driver based on the remote control signal in response to determining that the power control signal thus received has yet to include the takeover message, and control the rotation speed of the driver based on the power control signal after determining that the power control signal thus received includes the takeover message.

According to another aspect of the disclosure, the wall-mounted ceiling fan control system includes a fan control device to be mounted on a wall, a ceiling fan as mentioned above, and a power line. The fan control device includes a control interface module and a control module. The control interface module is operable by a user, and is configured to output an interface control signal based on an operation of the user on the control interface module. The control module is electrically connected to the control interface module, and is configured to receive an alternating current (AC) mains signal, alter a voltage waveform of the AC mains signal based on the interface control signal, output the AC mains signal thus altered as a power signal, and in response to the control module fulfilling a predetermined condition, output a takeover message through the power signal. The ceiling fan is configured to receive the power signal from the fan control device. The power line is electrically connected between the fan control device and the ceiling fan. The ceiling fan receives the power signal from the fan control device via the power line.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a wall-mounted ceiling fan control system according to a first embodiment of the disclosure.

FIG. 2 is a schematic diagram of a control interface module according to an embodiment of the disclosure.

FIG. 3 is a schematic diagram illustrating the wall-mounted ceiling fan control system in use with a ceiling fan according to an embodiment of the disclosure.

FIG. 4 is a waveform diagram illustrating a voltage waveform of an alternating current (AC) mains signal.

FIG. 5 is a waveform diagram illustrating a voltage waveform of a power signal according to a first example of the power signal for message transmission.

FIGS. 6 and 7 are waveform diagrams respectively illustrating voltage waveforms that correspond respectively to different logic values according to a second example of the power signal for message transmission.

FIG. 8 is a waveform diagram illustrating a voltage waveform of the power signal according to a third example of the power signal for message transmission.

FIG. 9 is a block diagram illustrating the wall-mounted ceiling fan control system according to a second embodiment of the disclosure.

FIG. 10 is a waveform diagram illustrating a voltage waveform of an illuminator-power signal according to an embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

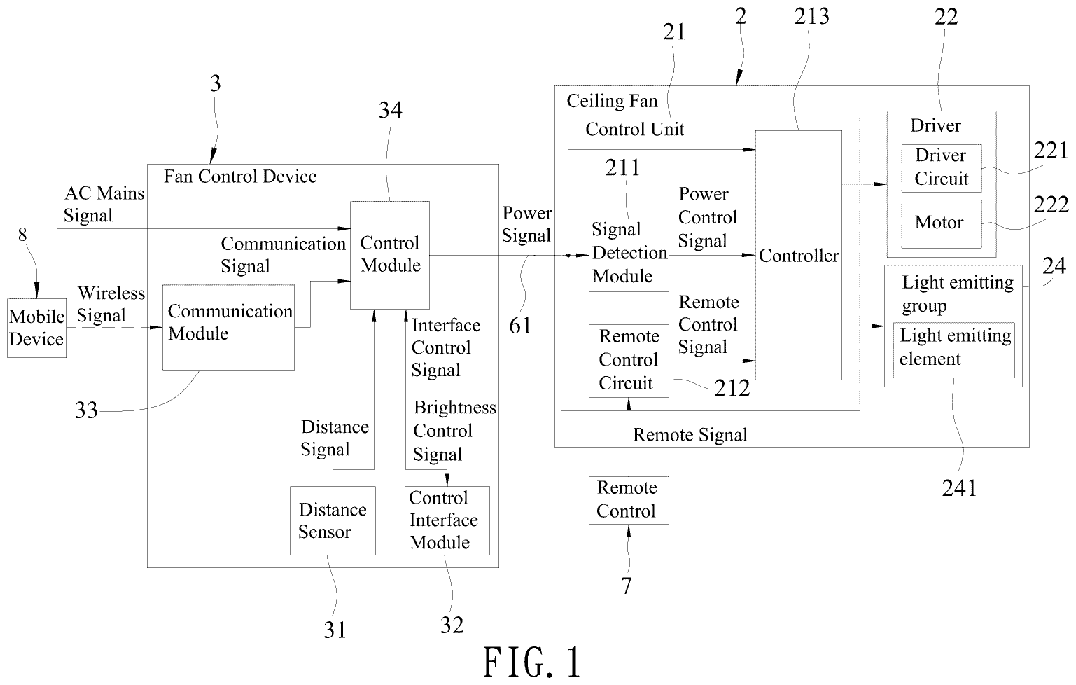

Referring to FIG. 1, a wall-mounted ceiling fan control system according to a first embodiment of the present disclosure includes a ceiling fan 2, a fan control device 3, and a power line 61 electrically connected between the fan control device 3 and the ceiling fan 2. The wall-mounted ceiling fan control system of this disclosure may be selectively connected to a remote control 7 or a mobile device 8. The mobile device 8 may be exemplified by a portable electronic device such as a smartphone or a laptop, but is not limited to such.

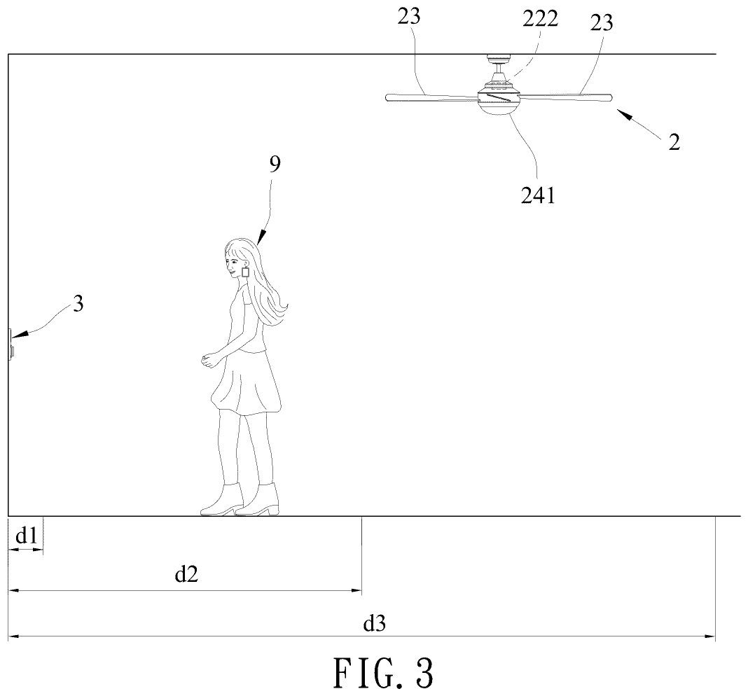

Further referring to FIG. 3, the ceiling fan 2 includes a control unit 21, a driver 22 that is electrically connected to the control unit 21, a plurality of fan blades 23 that are connected to the driver 22, and that are rotatably driven by the driver 22, and a light emitting group 24 that is electrically connected to the control unit 21.

The control unit 21 includes a signal detection module 211, a remote control circuit 212, and a controller 213. The signal detection module 211 is configured to receive a power signal, and output a power control signal based on the power signal thus received. In one embodiment, the signal detection module 211 may use, for example, but not limited to, a zero-crossing detector or a comparator circuit to determine a frequency and a waveform cycle of the power signal. In some embodiments, depending on the communication protocol that is used, the signal detection module 211 may be used in cooperation with a decoder (not shown) that corresponds to the communication protocol to obtain messages included in the power signal, and to output the power control signal accordingly. The remote control circuit 212 is configured to receive a remote signal from the remote control 7, and output a remote control signal based on the remote signal thus received. For example, the remote signal may be transmitted via radio frequency (RF) wireless communication. Specifically, the wireless communication may be established in compliance with communication protocols such as Wi-Fi®, Bluetooth®, and ZigBee®, but the disclosure is not limited in this respect.

The controller 213 may be exemplified by an integrated circuit, such as a processor or a microcontroller (MC), which is capable of performing computational and communication functions, but the disclosure is not limited in this respect. The controller 213 is electrically connected to the signal detection module 211, the remote control circuit 212, the driver 22 and the light emitting group 24. The controller 213 is configured to receive the power signal as a power source, and receive the power control signal from the signal detection module 211. The controller 213 is further configured to determine whether the power control signal thus received includes a takeover message. In response to determining that the power control signal thus received has yet to include the takeover message, the controller 213 operates in a remote control mode, and in the remote control mode, the controller 213 controls a rotation speed of the driver 22 based on the remote control signal. The controller 213, after determining that the power control signal thus received includes the takeover message, controls the rotation speed of the driver 22 based on the power control signal. That is to say, when the controller 213 determines that the power control signal thus received has yet to include the takeover message, the ceiling fan 2 is controlled by the remote control 7; and after the controller 213 has determined that the power control signal thus received includes the takeover message, the ceiling fan 2 is controlled by the fan control device 3.

The driver 22 includes a driver circuit 221 electrically connected to the controller 213, and a motor 222 electrically connected to the driver circuit 221. The driver circuit 221 is controlled by the controller 213 to drive the motor 222. Specifically, the controller 213 controls the driver circuit 221 to drive the motor 222 to start rotating, to stop the motor 222 from rotating, to change a rotation direction of the motor 222, or to adjust a rotating speed of the motor 222, but the disclosure is not limited in this respect. The light emitting group 24 includes at least one light emitting element 241. The light emitting element 241 may be exemplified as a light emitting diode (LED), but is not limited to such. In one embodiment, the controller 213 controls the light emitting group 24 to change a brightness level of the light emitting element 214. Specifically, the controller 213 may control the light emitting group 24 to emit light, to not emit light, or to adjust the brightness level of light emitted thereby. Since ways of the controller 213 controlling the driver circuit 221 to drive the motor 222, and ways of the controller 213 controlling the light emitting element 241 to emit light are well known in the art, and are not the focus of this disclosure, further descriptions thereof will be omitted for the sake of brevity.

The fan control device 3 is mounted on a wall, and includes a distance sensor 31, a control interface module 32, a communication module 33, and a control module 34.

The distance sensor 31 is configured to measure a distance of a user 9 with respect to the distance sensor 31, and output a distance signal based on the distance of the user 9 thus measured. In one embodiment, the distance sensor 31 may, for example, use time-of-flight (ToF) technology to measure the distance, but is not limited to such.

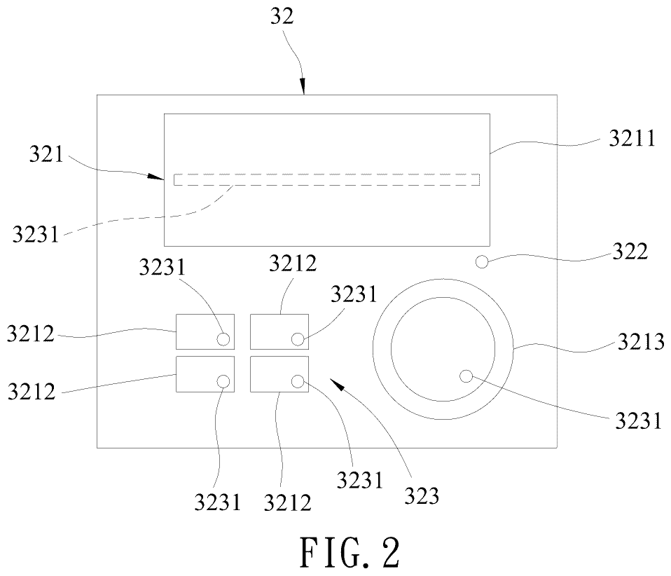

Further referring to FIG. 2, the control interface module 32 includes a control interface 321, an indicator 322, and an interface light-emitting group 323 disposed in correspondence to the control interface 321. The control interface 321 is operable by the user 9 (i.e., allow the user 9 to perform an operation thereon), and is configured to output an interface control signal based on the operation of the user 9 on the control interface module 32. In one embodiment, the control interface 321 includes a display 3211 for displaying information, a plurality of buttons 3212, a speed knob 3213 for adjusting a fan speed of the ceiling fan 2. The interface light-emitting group 323 includes a plurality of interface lights 3231 disposed in correspondence to the display 3211, the buttons 3212, and the speed knob 3213. The buttons 3212 are configured to allow the user 9 to perform operations thereon. In one embodiment, the buttons 3212 are respectively used for turning on/off the ceiling fan 2, turning on/off the light emitting group 24, adjusting a brightness level of the light emitting group 24, and transmitting the takeover message, but the disclosure is not limited in this respect. The indicator 322 and the interface lights 3231 are configured to adjust a brightness level (e.g., turning on/off, or adjusting the brightness level) of light emitted thereby based on a brightness control signal.

The communication module 33 is electrically connected to the control module 34, and is adapted to be communicatively connected to the mobile device 8. The communication module 33 is configured to receive a wireless signal from the mobile device 8, and output a communication signal to the control module 34 based on the wireless signal thus received. The communication module 33 uses short-range wireless communication technologies to establish communication with the mobile device 8. In one embodiment, the communication module 33 uses the wireless communication technologies that comply with the Bluetooth® protocol (e.g., using frequencies above 2 gigahertz (GHz)) or the Wi-Fi® protocol, but the disclosure is not limited to such.

The control module 34 is configured to receive an alternating current (AC) mains signal, and is electrically connected to the ceiling fan 2 via the power line 61. The control module 34 then transmits the power signal to the ceiling fan 2 as the power source for the ceiling fan 2 through the power line 61. The control module 34 is electrically connected to the distance sensor 31 for receiving the distance signal therefrom, the control interface module 32 for receiving the interface control signal therefrom, and the communication module 33 for receiving the communication signal therefrom. The control module 34 is further configured to output the brightness control signal and the power signal based on the distance signal, the interface control signal, and the communication signal thus received. The control module 34 is further configured to alter a voltage waveform of the AC mains signal based on the interface control signal or the communication signal, and output the AC mains signal thus altered as the power signal. In response to the control module 34 fulfilling a predetermined condition, the control module 34 outputs the takeover message through the power signal. In one embodiment, the predetermined condition is fulfilled upon occurrence of a first instance, a second instance, or a third instance. For example, the first instance is completion of power-on of the fan control device 3, the second instance is that the control interface module 32 is operated by the user 9 to output the interface control signal that corresponds to a transmission of the takeover message, and the third instance is that the control interface module 32 is operated by the user 9 to output the interface control signal that corresponds to the transmission of the takeover message within a predetermined time period after the fan control device 3 has been powered on. However, the predetermined condition is not limited to this disclosure. The control module 34 may be exemplified by an integrated circuit, such as a processor or a microcontroller unit (MCU), which is capable of performing computational functions, but the disclosure is not limited in this respect.

In a case where the ceiling fan 2 is used without the fan control device 3, and the ceiling fan 2 receives the AC mains signal as the power source directly from the mains, the AC mains signal thus received from the mains does not include the takeover message. In this case, the controller 213 operates in the remote control mode, and controls the driver 22 based on the remote control signal. That is to say, in this case, the user 9 performs operations on the remote control 7, and the remote control 7 outputs the remote signal based on operations of the user 9 to control operations of the ceiling fan 2.

In another case where the ceiling fan 2 is connected to the fan control device 3 via the power line 61, and the predetermined condition is fulfilled upon occurrence of the first instance, the second instance, or a combination of the first instance and the second instance, the control module 34 outputs the takeover message. In this embodiment, the control module 34 outputs the takeover message when the predetermined condition is fulfilled upon occurrence of the third instance, and the predetermined time period is one minute. However, the predetermined time period is not limited to this disclosure. Specifically, within one minute after the fan control device 3 is powered on, when the user 9 presses one of the buttons 3212 that corresponds to transmission of the takeover message for three to five seconds, the control module 34 outputs the takeover message. The controller 213, in response to receipt of the takeover message, stops controlling the driver 22 based on the remote control signal, and starts controlling the driver 22 based on the power control signal. That is to say, in response to receipt of the takeover message, the controller 213 stops being controlled by the remote control 7, and switches to being controlled by the fan control device 3.

Referring to FIGS. 1, 4 and 5, the power signal includes a plurality of waveform cycles 4. When the control module 34 is not in a message transmission state, the control module 34 is not transmitting messages through the power line 61, a voltage waveform of the power signal is substantially the same as the voltage waveform of the AC mains signal that is received from the mains (hereinafter referred to as “the original AC signal 51”), and the ceiling fan 2 receives the power signal that is the original AC signal 51 as the power source. For example, the AC mains signal has a voltage of 100 V to 240 V at 50 Hz or 60 Hz. When the control module 34 is in the message transmission state, the control module 34 is transmitting messages through the power line 61, and each of the waveform cycles 4 includes a power region 41 and a message region 42. Each of the waveform cycles 4 has a positive half-cycle and a negative half-cycle. Specifically, for each of the waveform cycles 4, the power region 41 has a positive portion 411 located at the positive half-cycle of the waveform cycle 4, and a negative portion 412 located at the negative half-cycle of the waveform cycle 4. The message region 42 has a first portion 421 located at the positive half-cycle of the waveform cycle 4, and a second portion 422 located at the negative half-cycle of the waveform cycle 4. In the positive half-cycle of the waveform cycle 4, the first portion 421 of the message region 42 is prior to the positive portion 411 of the power region 41; in the negative half-cycle of the waveform cycle 4, the second portion 422 of the message region 42 is prior to the negative portion 412 of the power region 41. By virtue of the above arrangements, some space can be gained for message transmission by utilizing early stages of the positive half-cycle and the negative half-cycle of the original AC signal 51 that have voltages near 0 V.

In one embodiment, a voltage waveform in the power region 41 is the same as a portion of the voltage waveform of the AC mains signal. The message region 42 is used for message transmission. A peak voltage of a voltage waveform in the message region 42 is lower than a peak voltage of the voltage waveform of the AC mains signal. For example, message transmission in the message region 42 may be achieved by using a universal asynchronous receiver/transmitter (UART) communication protocol (e.g., using a RS-232) or a controller area network (CAN) communication protocol, and may use a voltage of 3.3 V, 5 V or 15 V.

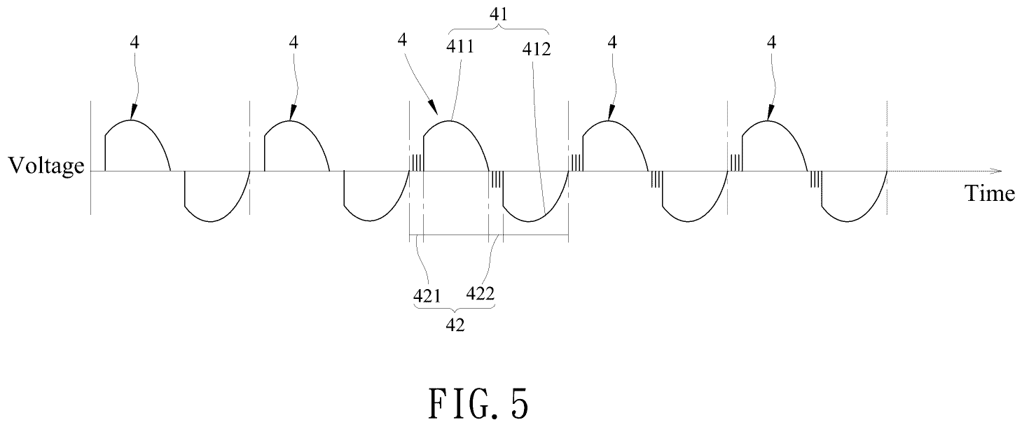

Referring to FIG. 5, in this embodiment, the power signal that is outputted by the control module 34 based on the interface control signal when the control module 34 is in the message transmission state includes the takeover message and a control message. The control message corresponds to the operations of the user 9 on the control interface module 32. In a first example of the power signal for message transmission, the takeover message may be included in a first two to three of the waveform cycles 4, and the control message may be included in a subsequent three to five of the waveform cycles 4. In this example, the control module 34 uses the first two of the waveform cycles 4 of the power signal to transmit the takeover message, and the subsequent three of the waveform cycles 4 of the power signal to transmit the control message. Specifically, transmission of electricity is stopped in the message regions 42 respectively of said first two of the waveform cycles 4 to serve as the takeover message. The control message is included in the message region 42 of each of said subsequent three of the waveform cycles 4 to be transmitted to the controller 213. That is to say, the control module 34 transmits the control message three times respectively through said subsequent three of the waveform cycles 4. In a variation of the first example, the control module 34 may first transmit two to three of the waveform cycles 4 where the transmission of electricity is stopped in the message regions 42 respectively of said two to three of the waveform cycles 4 in the power signal to the controller 213 in order to inform the controller 213 of a start of message transmission.

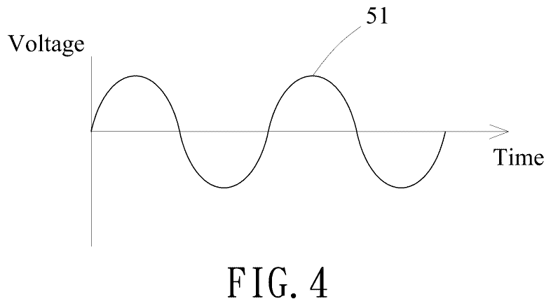

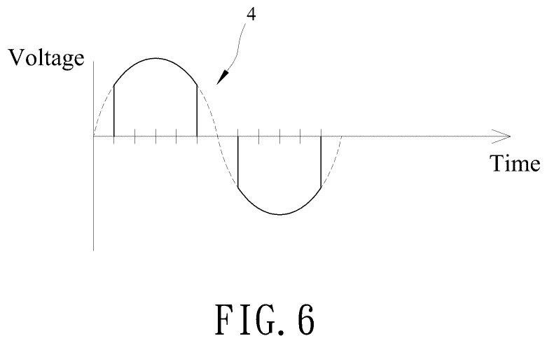

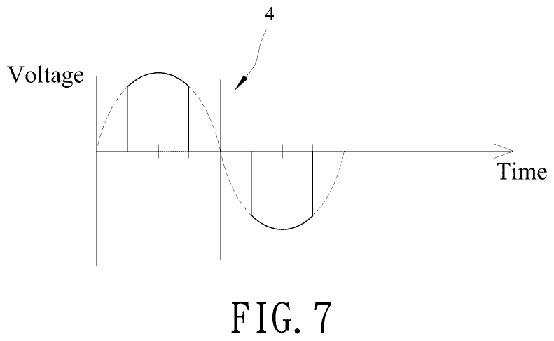

Referring to FIGS. 4, 6 and 7, in a second example of the power signal for message transmission, the control module 34 directly uses the waveform cycles 4 of the power signal to transmit messages in a form of a digital signal. When the control module 34 is not in the message transmission state, the voltage waveform of the power signal is substantially the same as the voltage waveform of the original AC signal 51. When the control module 34 is in the message transmission state, each of the waveform cycles 4 is trimmed by a phase portion. The phase portion includes a leading segment of the positive half-cycle, a trailing segment of the positive half-cycle, a leading segment of the negative half-cycle, and a trailing segment of the negative half-cycle that are of equal angular duration. For each of the waveform cycles 4, a total angular duration of the phase portion that is trimmed corresponds to a logic value. In the second example, the total angular duration of the phase portion that is trimmed in the waveform cycle 4 in FIG. 6 is equal to 120 degrees, which corresponds to the logic 1. The total angular duration of the phase portion that is trimmed in the waveform cycle 4 in FIG. 7 is equal to 180 degrees, which corresponds to the logic 0. Specifically, each of the leading segment of the positive half-cycle, the trailing segment of the positive half-cycle, the leading segment of the negative half-cycle, and the trailing segment of the negative half-cycle of the phase portion that is trimmed in the waveform cycle 4 corresponding to the logic 1 in FIG. 6 is of an angular duration of 30 degrees, and in the waveform cycle 4 corresponding to the logic 0 in FIG. 7 is of an angular duration of 45 degrees. In a variation of the second example, for a single waveform cycle 4, when the total angular duration of the phase portion that is trimmed is less than 15 percent of the waveform cycle 4, the waveform cycle 4 is set to correspond to the logic 1, and when the total angular duration of the phase portion that is trimmed is more than 25 percent of the waveform cycle 4, the waveform cycle 4 is set to correspond to the logic 0, but the disclosure is not limited in this respect. By virtue of the above arrangements, different logic values can be transmitted by reducing portions of the positive half-cycle and the negative half-cycle of the original AC signal 51 that have voltages near 0 V.

In one embodiment, each of the waveform cycles 4 indicates a logic bit, and in the message transmission state, N number of the waveform cycles 4 that indicate N number of logic bits correspond to a predetermined message, where N≥2. In such an embodiment, for example, each predetermined message may be transmitted in an eight bit format which corresponds to eight waveform cycles 4, and transmission of the eight waveform cycles 4 may be repeated three to five times to avoid erroneous actions caused by information loss. In this embodiment, the predetermined message is the takeover message or the control message.

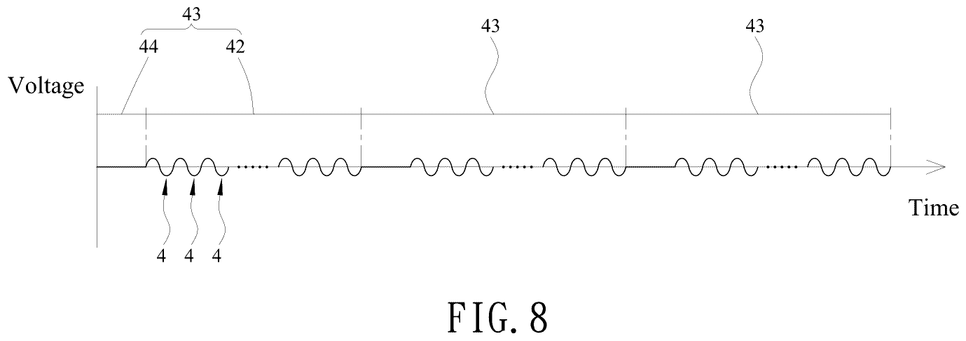

Referring to FIGS. 4 and 8, a third example of the power signal for message transmission is shown in FIG. 8. When the control module 34 is not in the message transmission state, the voltage waveform of the power signal is substantially the same as the voltage waveform of the original AC signal 51. When the control module 34 is in the message transmission state, the power signal includes a plurality of message waveform groups 43. Each of the message waveform groups 43 includes a message start region 44 in which transmission of electricity is stopped, and a message region 42 that includes the waveform cycles 4. In the third example of the power signal for message transmission, a number of the waveform cycles 4 in the message region 42 corresponds to the predetermined message. In one embodiment, a time length of the message start region 44 is equal to a time length of two waveform cycles 4. For each of the message waveform groups 43, the number of the waveform cycles 4 included in the message region 42 that equals to 12 corresponds to the predetermined message that is the takeover message. The number of the waveform cycles 4 included in the message region 42 that equals to 18 and 22 correspond respectively to the predetermined messages that are the control messages for controlling the motor 222 to rotate in a first speed and in a second speed that is higher than the first speed. Each of the message waveform groups 43 that corresponds to the predetermined message may be repeatedly transmitted three to five times to avoid erroneous actions caused by information loss.

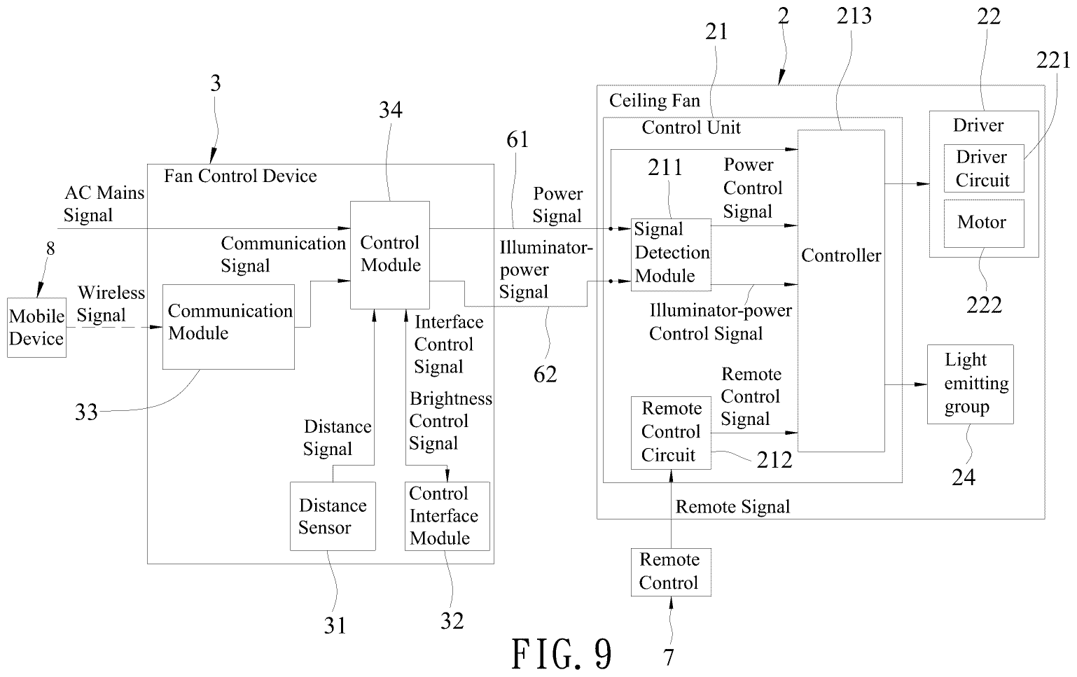

Referring to FIG. 9, the wall-mounted ceiling fan control system according to a second embodiment of the disclosure is presented. The second embodiment differs from the first embodiment in that, the second embodiment further includes an illuminator-power line 62 electrically connected between the ceiling fan 2 and the fan control device 3. In the second embodiment, the control module 34 transmits the power signal for controlling the motor 222 via the power line 61, and transmits an illuminator-power signal for controlling the light emitting group 24 via the illuminator-power line 62, where the illuminator-power signal is generated by the control module 34 based on the interface control signal or the communication signal. The signal detection module 211 is further configured to receive the illuminator-power signal, and output an illuminator-power control signal based on the illuminator-power signal thus received. The controller 213 is further configured to receive the illuminator-power control signal, transmit the illuminator-power control signal as a power source for the light emitting group 24, and control operations of the light emitting group 24 based on the illuminator-power control signal.

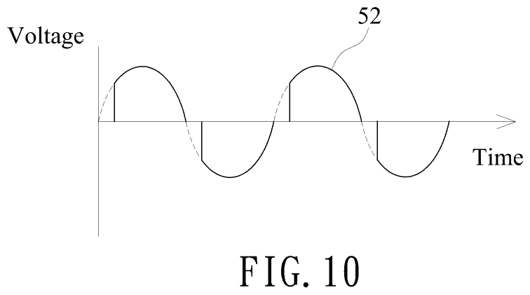

Referring to FIG. 10, the control module 34 controls the brightness level of the light emitting group 24 by controlling a conduction angle (i.e., a total angular duration in which transmission of electricity occurs) of a voltage waveform of the illuminator-power signal 52. That is to say, when the conduction angle is increased, more electricity is provided to the light emitting group 24, thereby increasing the brightness level of the light emitting group 24. Since the ways of adjusting the conduction angle to control the brightness level of the light emitting group 24 are well known in the art, further descriptions thereof will be omitted for the sake of brevity.

Referring to FIGS. 1 to 3, the control module 34 stores a plurality of predetermined distance ranges that are different from each other. The control module 34 is further configured to select one of the predetermined distance ranges based on the distance signal, and to output the brightness control signal based on said one of the predetermined distance ranges thus selected to the indicator 322 or the interface light-emitting group 323 in order to control the indicator 322 or the interface light-emitting group 323 to change the brightness level of light emitted thereby (e.g., turning on/off or adjusting the brightness level of the indicator 322 or the interface light-emitting group 323). In some embodiments, the control module 34 is further configured to output the power signal (e.g., in the first embodiment) or the illuminator-power signal (e.g., in the second embodiment) that corresponds to said one of the predetermined distance ranges to the control unit 21 in order to change the brightness level of light emitted by the light emitting group 24 (e.g., turning on/off or adjusting the brightness level of the light emitting group 24).

The control module 34 is further configured to, in response to the control module 34 determining that the distance indicated by the distance signal is not within any one of the predetermined distance ranges, control the indicator 322 and the interface light-emitting group 323 to not emit light, and switches into a sleep mode. In the sleep mode, the control module 34 shuts down most of its functions to reduce unnecessary power consumption. Since details related to the control module 34 being in the sleep mode is well known in the art, further description thereof will be omitted for the sake of brevity.

In one embodiment, the predetermined distance ranges include a first predetermined range (e.g. from 0 to d1 in FIG. 3), a second predetermined range (e.g., from d1 to d2 in FIG. 3), and a third predetermined range (e.g., from d2 to d3 in FIG. 3) that correspond respectively to distances between the distance sensor 31 and the user 9 from relatively near to relatively far. Specifically, the first predetermined range is within a first predetermined distance (e.g., 30 cm) from the distance sensor 31, where the first predetermined range is 0 to 30 cm; the second predetermined range is within a second predetermined distance (e.g., 3 m) from the first predetermined distance, where the second predetermined range is 30 cm to 3 m; the third predetermined range is within a third predetermined distance (e.g., 6 m) from the second predetermined distance, where the third predetermined range is 3 m to 6 m.

When the user 9 is approaching the fan control device 3 from a distance, and the control module 34 determines that the user 9 is at a distance that corresponds to the third predetermined range (e.g., 3 m to 6 m) based on the distance signal, the control module 34 outputs the brightness control signal that controls the indicator 322 to emit light in order to enable the user 9 to locate the fan control device 3 based on the light emitted by the indicator 322. As the user 9 approaches closer towards the fan control device 3, and the control module 34 determines that the user 9 is at a distance that corresponds to the second predetermined range (e.g., 30 cm to 3 m) based on the distance signal, the control module 34 then outputs the brightness control signal that controls the interface lights 3231 of the interface light-emitting group 323 to emit light. At this time, the interface lights 3231 may be controlled to emit light at a brightness level that is just sufficient for the user 9 to locate the display 3211, the buttons 3212, and the speed knob 3213. When the user 9 approaches closer towards the fan control device 3 and is in front of the fan control device 3, which indicates that the user 9 may want to start performing operations on the control interface module 32, and the control module 34 determines that the user 9 is at a distance that corresponds to the first predetermined range (e.g., 0 to 30 cm), the control module 34 outputs the brightness control signal that controls the interface light-emitting group 323 to increase the brightness level of the light emitted to a full brightness level in order to clearly show the display 3211, the buttons 3212, and the speed knob 3213. In some embodiments, after the control module 34 has controlled the interface light-emitting group 323 to increase the brightness level to the full brightness level, the control module 34 may also output the power signal to the ceiling fan 2 to control the light emitting group 24 to emit light, thereby allowing the user 9 to clearly identify the control interface module 32. At this time, the control module 34 switches from the sleep mode to an operating mode. In the operating mode, the control module 34 activates all its functions in preparation to execute operations based on operations of the user 9 on the control interface 321.

The user 9 may also perform operations on the mobile device 8 so that the mobile device 8 outputs the wireless signal based on operations of the user 9, and the communication module 33 outputs the communication signal to the control module 34 upon receipt of the wireless signal. Then, the control module 34 outputs the power signal based on the communication signal thus received to control operations of the ceiling fan 2 such as turning on/off, adjusting the fan speed of the ceiling fan 2, or adjusting the brightness level of the light emitting group 24.

In summary, the power line 61 is electrically connected between the ceiling fan 2 and the fan control device 3. The fan control device 3 transmits the power signal to the ceiling fan 2 as the power source via the power line 61. The power signal includes the control message for controlling operations of the ceiling fan 2. By virtue of the aforementioned arrangements, the control message can be transmitted simultaneously while the power signal is outputted to supply power to the ceiling fan 2, so that the ceiling fan 2 can receive the control message via the power line 61, thereby overcoming the problem of wireless signals being in interference with each other as faced by using conventional fan control devices which may cause erroneous actions of the ceiling fan 2.

The ceiling fan 2 includes the signal detection module 211, the remote control circuit 212, and the controller 213. Depending on whether the controller 213 has received the takeover message, the controller 213 may control the driver 22 to operate based on the remote control signal or the power control signal. By virtue of the aforementioned arrangements, the ceiling fan 2 is able to be controlled by the remote control 7 when the ceiling fan 2 receives the AC mains signal as the power source directly from the mains, and is able to be controlled by the fan control device 3 when the ceiling fan 2 receives the power signal from the fan control device 3 via the power line 61, thereby maintaining flexibility in application of the ceiling fan 2.

The fan control device 3 includes the control module 34, the distance sensor 31, the indicator 322, and the interface light-emitting group 323. The control module 34 determines the distance of the user 9 from the fan control device 3 based on the distance signal received from the distance sensor 31, selects one of the predetermined distance ranges based on the distance signal, and outputs the brightness control signal to control the brightness level of the indicator 322 or the interface light-emitting group 323. By virtue of the aforementioned arrangements, the brightness level of the indicator 322 or the interface light-emitting group 323 may be adjusted as the user 9 is approaching nearer to the fan control device 3, thereby enabling the user 9 to easily locate the fan control device 3 and to perform operations thereon.

In addition, the control module 34 controls the brightness level of the indicator 322 or the interface light-emitting group 323 based on the predetermined distance ranges that are different from each other, so that the brightness level of the indicator 322 or the interface light-emitting group 323 is gradually increase to enhance visibility of the control interface module 32 as the user 9 approaches the control interface module 32. When the user 9 is sufficiently near the control interface module 32, the control module 34 further increases the brightness level of the indicator 322 or the interface light-emitting group 323 to enable the user 9 to clearly locate the control interface module 32, and switches to the operating mode in preparation to execute operations based on operations of the user 9.

Furthermore, the communication module 33 may be connected to the mobile device 8, allowing the user 9 to control the ceiling fan 2 through the mobile device 8. Since people nowadays tend to have mobile devices nearby, enabling directly control of the ceiling fan 2 through the mobile device 8 further increases operational convenience.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A ceiling fan, comprising:
a driver;
a plurality of fan blades connected to said driver, and rotatably driven by said driver;
a signal detection module configured to receive a power signal, and output a power control signal based on the power signal thus received;
a remote control circuit configured to receive a remote signal, and output a remote control signal based on the remote signal thus received; and
a controller electrically connected to said driver, said signal detection module, and said remote control circuit, and configured to receive the power signal as a power source, receive the power control signal from said signal detection module, and determine whether the power control signal thus received includes a takeover message,
wherein said controller is further configured to, control a rotation speed of said driver based on the remote control signal in response to determining that the power control signal thus received has yet to include the takeover message, and control the rotation speed of said driver based on the power control signal after determining that the power control signal thus received includes the takeover message.

2. A wall-mounted ceiling fan control system, comprising:
a fan control device to be mounted on a wall, and including
a control interface module operable by a user, and configured to output an interface control signal based on an operation of the user on said control interface module, and
a control module electrically connected to said control interface module, and configured to receive an alternating current mains signal, alter a voltage waveform of the AC mains signal based on the interface control signal, output the AC mains signal thus altered as a power signal, and in response to said control module fulfilling a predetermined condition, output a takeover message through the power signal;
a ceiling fan as claimed in claim 1, configured to receive the power signal from said fan control device; and
a power line electrically connected between said fan control device and said ceiling fan, said ceiling fan receiving the power signal from said fan control device via said power line.

3. The wall-mounted ceiling fan control system as claimed in claim 2, wherein the power signal includes a plurality of waveform cycles each including a power region and a message region, a voltage waveform in the power region is the same as a portion of the voltage waveform of the AC mains signal, the message region is used for message transmission, and a peak voltage of a voltage waveform in the message region is lower than a peak voltage of the voltage waveform of the AC mains signal.

4. The wall-mounted ceiling fan control system as claimed in claim 2, wherein the power signal includes a plurality of waveform cycles each having a positive half-cycle and a negative half-cycle; and
wherein in a message transmission state, each of the plurality of waveform cycles is trimmed by a phase portion, the phase portion includes a leading segment of the positive half-cycle, a trailing segment of the positive half-cycle, a leading segment of the negative half-cycle, and a trailing segment of the negative half-cycle that are of equal angular duration, and for each of the plurality of waveform cycles, a total angular duration of the phase portion that is trimmed corresponds to a logic value.

5. The wall-mounted ceiling fan control system as claimed in claim 2, wherein the power signal includes a plurality of waveform cycles each indicating a logic bit, and in a message transmission state, N number of the plurality of waveform cycles that indicate N number of logic bits correspond to a predetermined message, where N≥2.

6. The wall-mounted ceiling fan control system as claimed in claim 2, wherein in a message transmission state, the power signal includes a plurality of message waveform groups each including a message start region in which transmission of electricity is stopped, and a message region including a plurality of waveform cycles, and a number of the plurality of waveform cycles in the message region corresponds to a predetermined message.

7. The wall-mounted ceiling fan control system as claimed in claim 2, wherein the predetermined condition is fulfilled upon occurrence of one of a first instance, a second instance and a third instance, and wherein the first instance is completion of power-on of said fan control device, the second instance is that said control interface module is operated by the user to output the interface control signal that corresponds to a transmission of the takeover message, and the third instance is that said control interface module is operated by the user to output the interface control signal that corresponds to the transmission of the takeover message within a predetermined time period after said fan control device has been powered on.

8. The wall-mounted ceiling fan control system as claimed in claim 2, wherein said fan control device further includes a distance sensor that is electrically connected to said control module, and that is configured to measure a distance of the user with respect to said distance sensor, and to output a distance signal based on the distance of the user thus measured;
wherein said control interface module includes a control interface configured to allow the user to perform an operation thereon and output the interface control signal based on the operation of the user, an indicator, and an interface light-emitting group disposed in correspondence to said control interface, and said indicator and said interface light-emitting group are configured to adjust a brightness level of light emitted thereby based on a brightness control signal; and
wherein said control module stores a plurality of predetermined distance ranges that are different from each other, and is further configured to select one of the plurality of predetermined distance ranges based on the distance signal, and to output the brightness control signal based on said one of the plurality of predetermined distance ranges thus selected to one of said indicator and said interface light-emitting group.

9. The wall-mounted ceiling fan control system as claimed in claim 8, wherein said control module is further configured to, in response to said control module determining that the distance indicated by the distance signal is not within any one of the plurality of predetermined distance ranges, control said indicator and said interface light-emitting group to not emit light, and switch into a sleep mode.

10. The wall-mounted ceiling fan control system as claimed in claim 8, wherein the plurality of predetermined distance ranges include a first predetermined range, a second predetermined range, and a third predetermined range that correspond respectively to distances between said distance sensor and the user from relatively near to relatively far, and said control module is further configured to output the brightness control signal that controls said indicator to emit light in response to the distance indicated by the distance signal corresponding to the third predetermined range, output the brightness control signal that controls said interface light-emitting group to emit light in response to the distance indicated by the distance signal corresponding to the second predetermined range, and output the brightness control signal that increases a brightness of said interface light-emitting group and switch into an operating mode in response to the distance indicated by the distance signal corresponding to the first predetermined range.

11. The wall-mounted ceiling fan control system as claimed in claim 2, wherein said fan control device further includes a communication module that is electrically connected to said control module, that is adapted to be communicatively connected to a mobile device, and that is configured to receive a wireless signal from the mobile device, and output a communication signal to said control module based on the wireless signal thus received, and said control module is configured to output the power signal based on the communication signal.
